(19) United States
(12) Patent Application Publication
(10) Pub. No.: US 2025/0055494 A1
(43) Pub. Date: Feb. 13, 2025

(54) Apparatus to regulate phone use without sacrificing quick phone access and connectivity

(71) Applicant: John Nguyen, Lake Elsinore, CA (US)

(72) Inventor: John Nguyen, Lake Elsinore, CA (US)

(73) Assignee: John Nguyen, Lake Elsinore, CA (US)

(21) Appl. No.: 18/900,793

(22) Filed: Sep. 29, 2024

(51) Int. Cl. H04B 1/3888; A45C 11/00

(52) U.S. Cl. CPC H04B 1/3888; A45C 2011/002; A45F 2200/0516

(57) ABSTRACT

This apparatus incorporates an integral pin permanently attached to a pouch or shell, designed to house mobile electronic devices. The key feature is a removable, swappable, and exchangeable tag that engages with the pin, providing customizable security and controlled access to the device. By adjusting or replacing the tag, the opening can be secured at varying levels, enhancing security while allowing access to essential functions such as answering calls or recording audio. To streamline unlocking, especially during schoolwide emergencies, the apparatus includes a common unlocking mechanism or tool, ensuring quick, standardized access. This system allows for easy maintenance and repair, with tags being replaceable without compromising the structure. The design ensures quick access in emergencies while maintaining safety by preventing accidental removal of the device. The swappable tag system allows for different levels of security, making it adaptable to various needs while providing immediate, safe access in critical situations.

### CROSS-REFERENCE TO RELATED APPLICATIONS

This application incorporates by reference in its entirety the disclosures of the following U.S. patents and patent applications:
1. U.S. Pat. No. 9,819,788B2, filed on Apr. 22, 2014, titled “System and Apparatus for Selectively Limiting User Control of an Electronic Device,” issued to Graham Dugoni on Nov. 14, 2017.
2. U.S. Patent Application Publication No. US20050279660A1, filed on Feb. 13, 2002, titled “Textile Item Comprising Receptacle for Housing a Portable Electronic Device, Particularly a Textile Clothing Item,” published on Dec. 22, 2005, by Emmanuel Deflin.
3. U.S. Patent Application Publication No. US20120187003A1, filed on Jan. 21, 2011, titled “Soft Alarming Safer,” published on Jul. 26, 2012, by Sensormatic Electronics, LLC.
4. U.S. Patent Application Publication No. US20080202958A1, filed on Feb. 22, 2007, titled “Stretchable, Variable Volume Carrying Case and Methods for Transporting Items,” published on Aug. 28, 2008, by Colleen Marie Hanlen.

### GOVERNMENT CONTRACT

Not applicable

### STATEMENT OF FEDERALLY SPONSORED RESEARCH OR DEVELOPMENT

Not applicable

### NAMES OF JOINT RESEARCH AGREEMENT

Not applicable

### REFERENCE TO A SEQUENCE LISTING

Not applicable

### TECHNICAL FIELD

The present invention relates to security enclosures for portable electronic devices, specifically to pouches or shells that incorporate an integral pin and a removable, exchangeable tag system. This system provides customizable security levels and controlled access to the device, enabling secure containment while allowing rapid access during emergencies and maintaining essential device functionalities such as answering calls or recording audio.

### BACKGROUND OF THE INVENTION

Attempts have been made to provide balanced solutions for eliminating distractions from mobile electronic devices while allowing users to access essential functions. However, none, including U.S. Pat. No. 9,819,788 to Dugoni, effectively address these needs. Dugoni's patent discloses a “system and apparatus for selectively limiting user control of a mobile electronic device,” but it is deficient because it “renders the electronic device inaccessible and incontrollable” when the case is locked. The design consists of large, hard plates that mate together to completely close the openings, preventing any access or interaction with the device inside. This makes the device “physically impenetrable” by the user when locked.

Dugoni's locking system is part of the phone case and integrated defined geographic fencing or timers to unlock the device, which can be highly dangerous in school settings, especially during emergencies where students need to contact parents or emergency services. In life-threatening situations such as shootings, earthquakes, fires, or terrorist attacks, immediate access to a phone is critical, but Dugoni's design delays this access, as users must bring their case outside the defined geographic area. This delay in the unlocking process, particularly during large-scale emergencies, is inefficient and potentially life-threatening.

Moreover, due to its defined geographic or timer predetermined conditions, the Dugoni case does not allow individual teachers or school staff to unlock the pouch in their classrooms for educational, medical, or emergency needs. The case remains locked until the user leaves a predefined geographic area or a predetermined time elapses, creating further barriers in time-sensitive situations. Additionally, Dugoni's pouches make it impossible for users to engage with their device while it's secured, meaning students or teachers cannot even use essential features like emergency calls or commands when the phone is locked. These limitations make such systems impractical for environments like schools, where flexibility and safety are paramount. This invention addresses these issues by allowing customizable levels of access and control while maintaining security, ensuring quick response times in emergencies without sacrificing safety.

The current invention offers a novel solution to the limitations of products like Dugoni and similar products. Unlike the Dugoni system, which integrates all locking components directly into the case and restricts access based on predefined geographic areas or timers, this invention introduces a removable, swappable, and exchangeable tag system. This allows for customizable security levels, enabling controlled access to the device at any time. The tag engages with an integral pin attached to the pouch, and the degree of access can be adjusted based on the selected tag, which are structures and functions not taught or enabled by Dugoni's rigid system.

This new apparatus provides a common unlocking mechanism or tool, streamlining access during schoolwide emergencies where rapid communication is critical. This ensures that large groups, such as students needing to contact parents, can quickly access their devices anywhere during any moment. Additionally, the customizable tag system allows individual teachers or administrators to unlock devices for medical, educational, or emergency purposes within their classrooms, a structure and function that Dugoni lacks.

Furthermore, this invention maintains user interaction with the device while it is housed within the pouch, unlike Dugoni's restrictive design of two large equal-size mating plates that entirely close and seal the opening, making it non-engageable and impenetrable by the user. However, this apparatus balances security with functionality, allowing access to essential functions, buttons, and ports for answering calls or recording audio without fully unlocking or removing the device.

The current invention not only addresses the functional limitations of products like Dugoni, but it also offers significant environmental and cost-saving benefits. Dugoni's pouch system, and other similar products, are designed with integrated locking mechanisms that cannot be repaired if a single component fails. When a part of the locking mechanism breaks or malfunctions, the entire pouch becomes unusable, leading to increased waste and environmental pollution. This design flaw contributes to a growing environmental hazard, as these pouches must be discarded rather than repaired, adding to landfill waste and harming the environment.

In contrast, the new apparatus introduces a removable, swappable, and exchangeable tag system that allows for easy repairs and maintenance. This innovation also ensures simple maintenance and repair, as the tags can be replaced or swapped without replacing the pouch or other components. If a tag or any part of the mechanism needs replacement, it can be swapped out without compromising the integrity of the pouch. This repairability reduces waste, making it a more environmentally sustainable solution. By extending the lifecycle of the pouch, schools and consumers can avoid the expensive costs associated with frequently replacing entire pouches, as is necessary with products like Dugoni's.

Additionally, this novel design contributes to a lower environmental impact by minimizing material waste during manufacturing. By using replaceable tags, the apparatus ensures that only small components are replaced when necessary, rather than discarding the entire product. This repairable system thus provides a more cost-effective and eco-friendly alternative for schools, consumers, and the environment.

### BRIEF SUMMARY OF THE INVENTION

The invention described is an apparatus designed to securely house a mobile electronic device, including accessories and additional devices, to reduce distractions by concealing the screen while still allowing access to essential functions. Constructed from durable materials such as woven fabric, silicone, cut-resistance fabric or signal-blocking fabric, the pouch or shell provides a secure environment for the device, ensuring both protection and usability.

A novel structure and function of the invention is its integral pin and removable tag system. The pin is permanently affixed to the structure of the pouch and interacts with a swappable tag, which securely closes the pouch by dividing the main opening into two smaller openings. This design restricts the removal of the device but still allows the user to interact with key functions and buttons, such as answering calls, issuing voice commands, or accessing ports. This unique system provides security while maintaining essential functionality, making the invention ideal for environments where full access to the device is unnecessary but basic interaction is required.

A novel structure and function of the invention is its customizable security system. The pouch allows users to swap out the tags, which can be equipped with various unlocking mechanisms such as physical keys, magnets, detachers, or even electrical signals, depending on the security requirements of the setting. Moreover, the design integrates a common universal unlocking tool, such as a magnet or key, that can unlock all pouches equipped with a specific tag. This ensures that, in critical situations such as emergencies, multiple pouches can be swiftly unlocked with a single, standardized tool, enhancing safety and convenience. This flexibility enables the pouch to be used in a wide range of environments, from high-security workplaces to personal use, where simpler locking methods may be sufficient. The universal unlocking mechanism makes the pouch highly adaptable for institutions where many users need coordinated access, such as schools or workplaces.

The invention also offers flexible access control. Users can change the tags without altering the fixed pin or any other part or structure of the pouch, allowing for quick adjustments in security levels. This is particularly valuable in scenarios where immediate access to the device is required, such as emergencies, ensuring that the pouch remains functional and responsive to varying conditions. By allowing for rapid adjustments and incorporating the common unlocking tool, the invention provides a highly adaptable solution without requiring additional tools or complicated adjustments.

To reduce distractions while maintaining functionality, the pouch includes design features that allow users to interact with their devices. These features may include partially translucent, touch-enabled panels and small access openings for buttons and ports. This structure ensures that the device's screen remains concealed, minimizing distractions while still providing enough access to essential functions when necessary. This balance between usability and distraction control makes the invention particularly suitable for environments such as schools or workplaces where focused attention is crucial.

Safety and durability are also key structures and functions of the invention. The integral pin eliminates the need for small, detachable components, which can pose choking hazards, especially in settings involving children. The swappable tags also improve the overall durability of the pouch with easy replacement of the tags, reducing wear and tear and ensuring long-term use in high-traffic environments such as educational institutions.

### BRIEF DESCRIPTION OF FIGURES

Here is a brief description of each figure:

FIG. 1 is the front view of the pouch with an integral and permanently affixed pin to the shell and a swappable tag.

FIG. 2 is a side view of the pouch with the tag engaged to the integral and permanently affixed pin on the pouch's shell. The swappable tag is engaged with the pin.

FIG. 3 depicts a variation of tag designs of different sizes and lengths.

FIG. 4 is a bird's view of the side of the pouch with an engaged tag and pin.

FIG. 5 is a bird's view of the side of the pouch where the pin is permanently affixed to it.

FIG. 6 is the front view of the pouch with the permanently affixed pin to the shell. It further shows that the pin divides the opening to maximize access and control of the device inside.

FIG. 7 is the view of the entire pin.

FIG. 8 illustrates how the tag engages with the pin, dividing the pouch's opening into two smaller sections, which at least partially closes the overall opening.

FIG. 9 is the variation of tag sizes and a standardized receiving hole to accept the pin to engage the locking mechanism with any tag.

FIG. 10 is a side view of the pouch at a different height to show possible variations in its dimensions, sizes, and volumes.

FIG. 11 illustrates how the limited access with a slit opening design works, showing the small opening allows partial interaction with the device while keeping it securely enclosed.

FIG. 12 is a front view of the defined opening with the possibility of indefinite shapes.

FIG. 13 is a bird's-eye view of the pouch, which has a small touch-enabled translucent panel for access and control of the device inside.

FIG. 14 is a view of the pouch with a translucent shell that maximizes a user's ability to access and engage without sacrificing screen distraction.

FIG. 15 is a bird' s-eye view of the pouch with a larger touch-enabled translucent panel that allows the user to engage with the device inside.

FIG. 16 shows the unlocking act to release the integral from the tag using a magnet, detacher, key, or other common unlocking means or tools.

FIG. 17 shows the disengaged tag from the pin, reverting the opening back to full size.

FIG. 18 illustrates tiers of unlocking tools used to unlock various tags requiring different strengths, including magnetic field, mechanical strength, magnetic pull, and signal strength needed for different tags.

### DETAILED DESCRIPTION OF THE INVENTION

The following detailed description provides a comprehensive overview of the embodiment(s) of the present invention. While specific examples are provided to illustrate the key components and functionalities, these examples are not intended to limit the scope of the invention. It should be understood that variations and modifications may occur without deviating from the fundamental principles outlined herein. Therefore, the embodiments described represent only certain possible configurations, and other variations, alterations, or equivalents are also intended to be included within the spirit and scope of the invention.

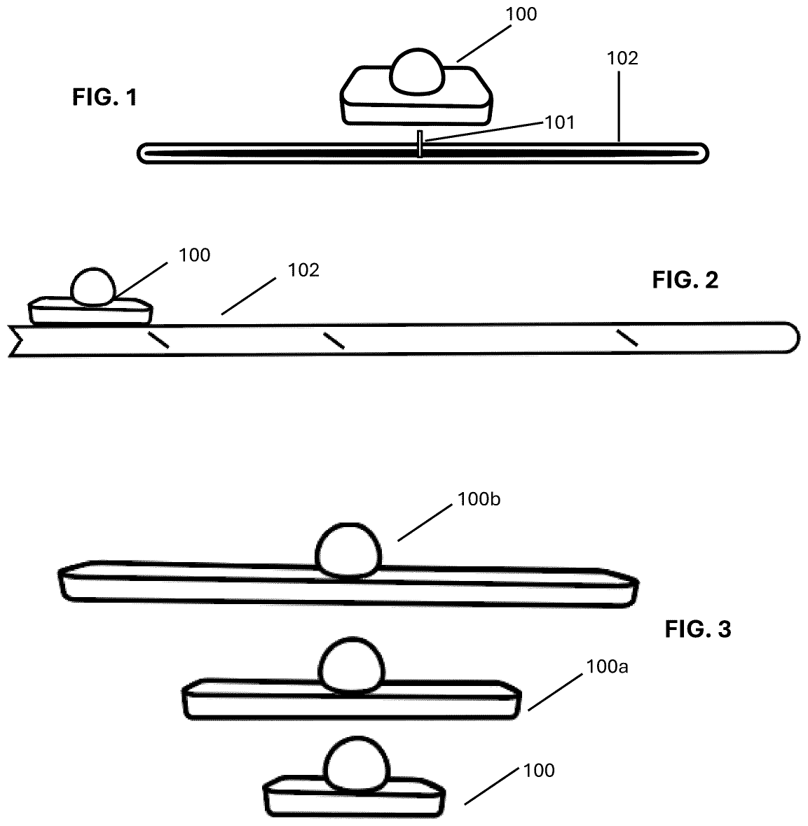

The embodiment of the multifunctional pouch designed to securely enclose and hold at least one mobile electronic device 105, including their accessories, while providing access and engagement with the device therein through a novel closure mechanism and touch-enabled translucent panels 104b and 104c, and a slit opening 104a to enable user interaction with the device without fully removing it from the pouch illustrated from different views in FIG. 1 through FIG. 17. The entire shell may be translucent 102c to maximize the visibility of the content in the pouch without preventing the users from seeing the screen clearly; therefore, it is impossible for the users to read text or images and cannot be distracted by the content on their mobile devices.

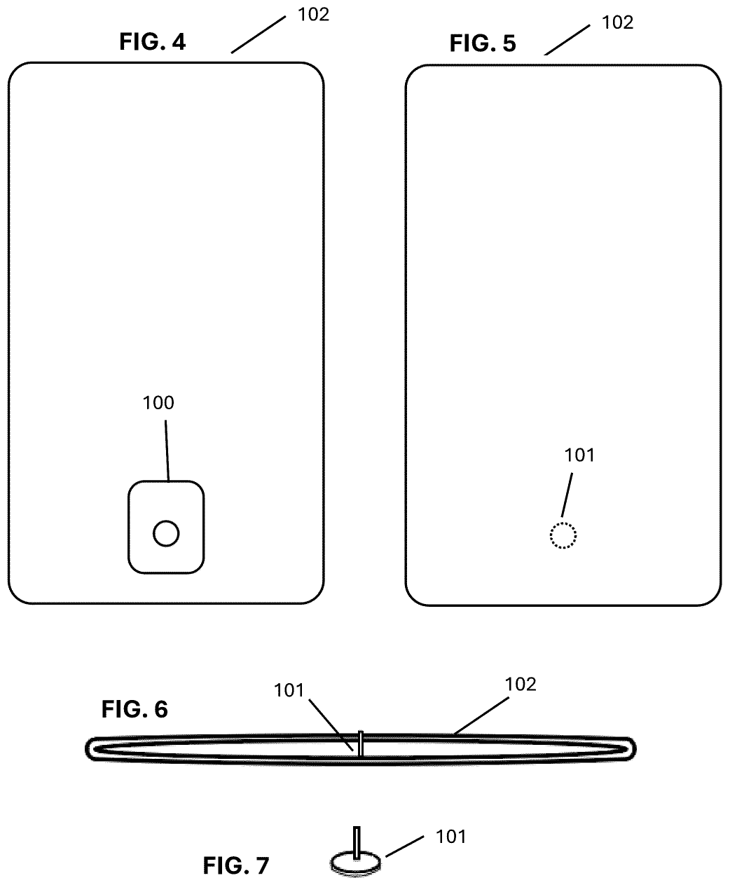

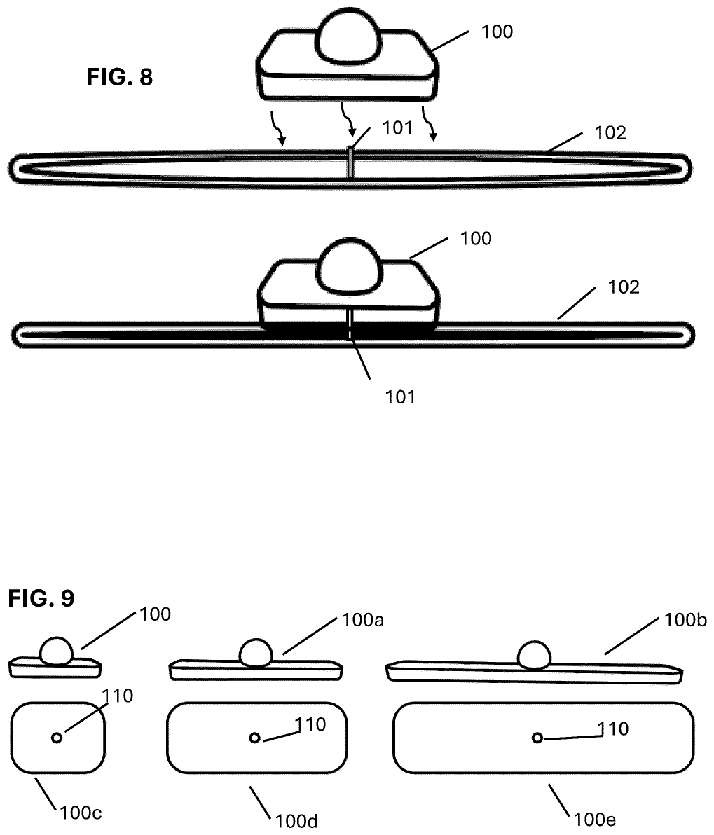

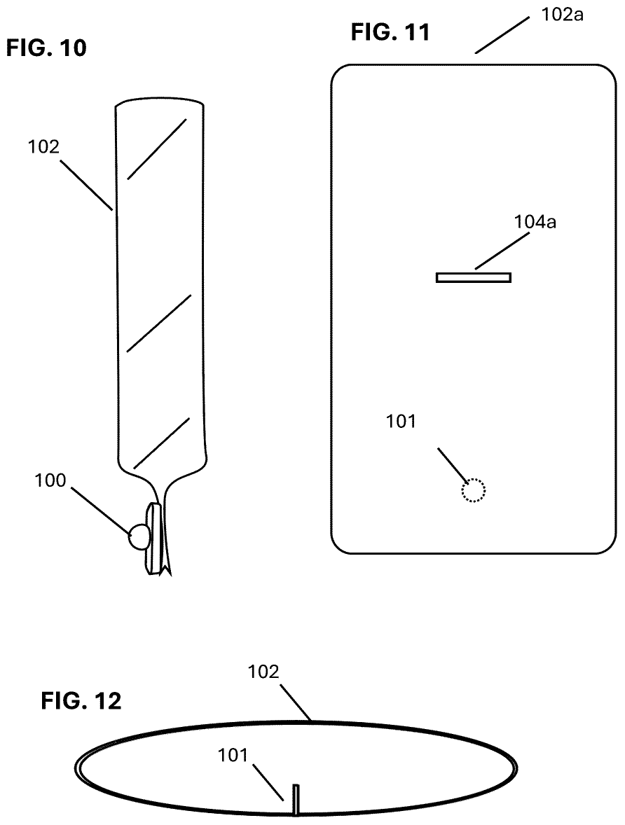

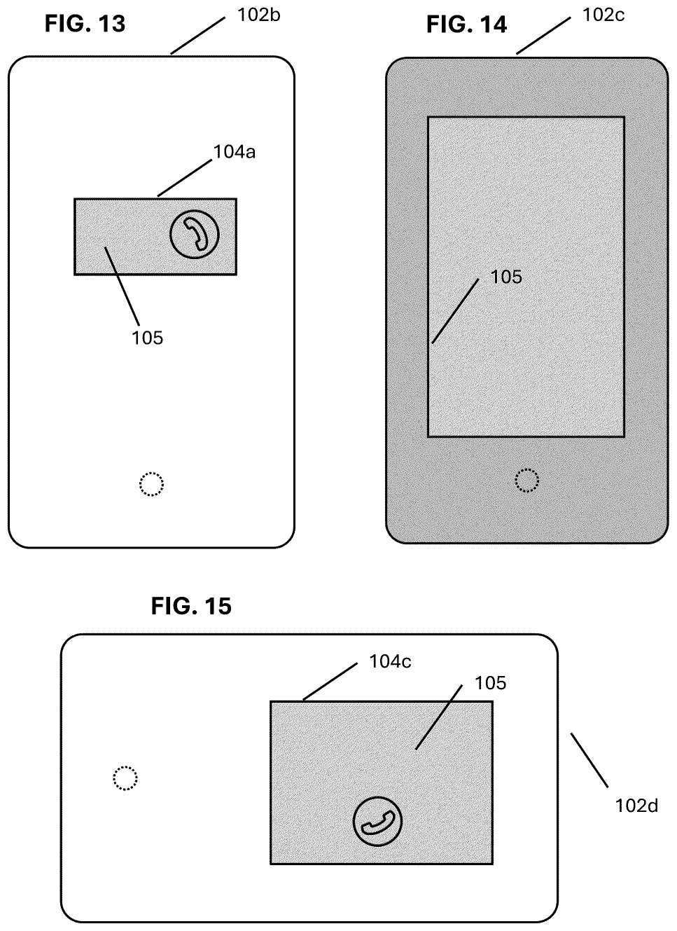

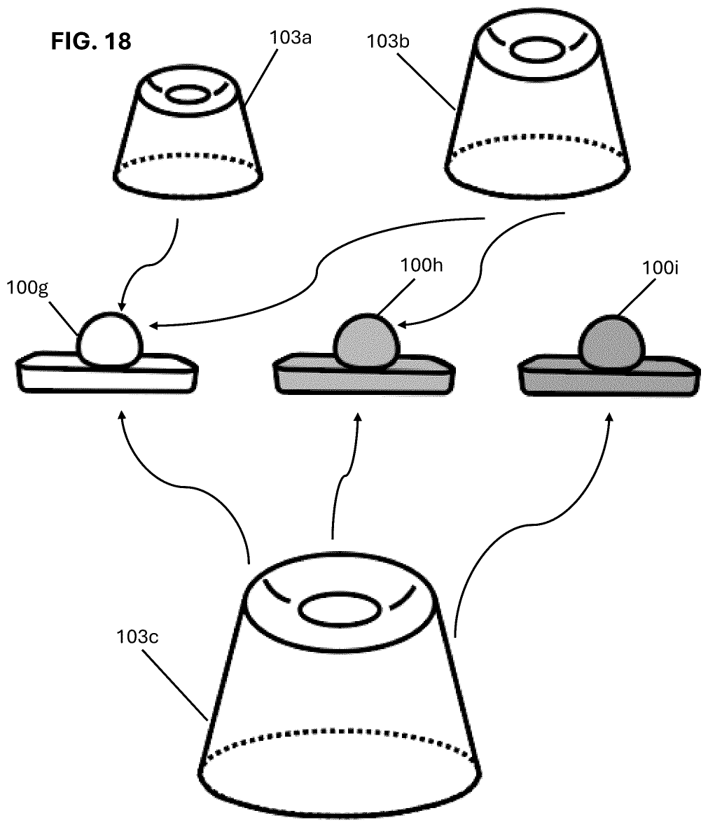

The closure system comprises an integral and permanently affixed pin 101 to the shell of pouch 102, as depicted in FIG. 1, FIG. 6, and FIG. 17. The shell of the pouch 102 may be constructed from durable materials such as woven fabric, silicone, cut-resistance fabric or signal-blocking fabric, the pouch or shell provides a secure environment for the device, ensuring both protection and usability, as depicted in FIG. 4, FIG. 5, FIG. 10, FIG. 11, FIG. 12, FIG. 13, FIG. 14, and FIG. 15. The swappable tags 100, 100a, and 100b may be varied with different designs, durability, locking strengths, and sizes to customize the levels of access or security as needed, as depicted in FIG. 9 and FIG. 18.

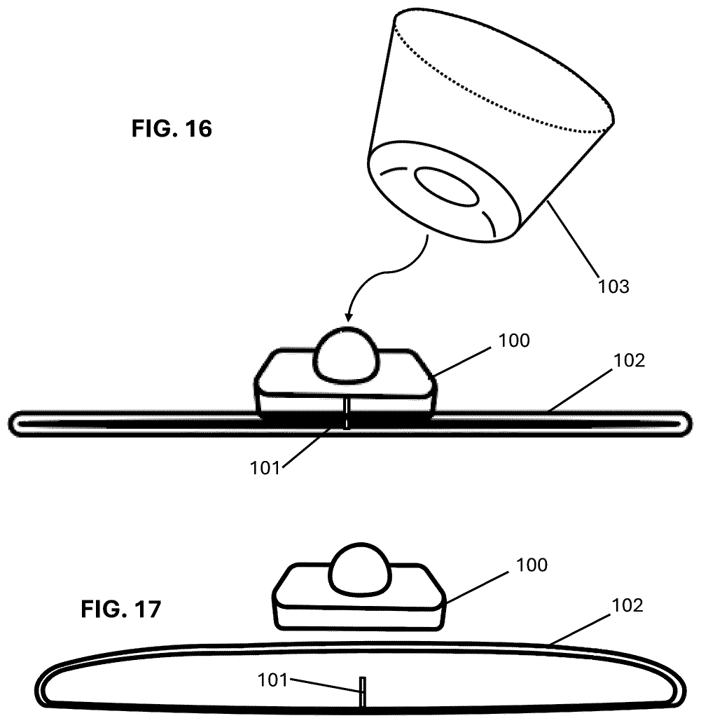

This integral and permanently affixed pin to the shell serves as a crucial structural feature and engages with swappable tags 100, 100a, and 100b to control the pouch's opening and locking, as depicted in FIG. 8. Engaging the swappable tags 100, 100a, and 100b to the integral pin on the pouch engages the locking to prevent a user from easily removing the devices inside the pouch, as depicted in FIG. 8. The swappable tags 100, 100a, and 100b comprise a standardized receiving hole to receive the pin and engage the locking to prevent the removal of the pin. All the same tags 100, 100a, and 100b can use a common unlocking means and tools, such as a magnet or detacher of different strength and magnetically full, to release the pin from that particular tag 100, 100a to 100i. In one embodiment in FIG. 19, a magnet, key, or detacher 103c with a strongest magnetic pull or electrical signal is capable of releasing the pin from all tags 100g 100h 100i that require that level of magnetic force or electrical strength, or less. However, a magnet, key, or detacher 103a with a weakest magnetic pull, or an electrical signal with insufficient strength, will not be able to release the pin from tags 100h and 100i that require a higher level of magnetic pull or electrical signal for detachment. The common and universal unlocking mechanism refers to a standardized, widely applicable system for unlocking the pouch by releasing the pin from the tag. This mechanism is designed to be compatible with all particular locking tags, ensuring that the pouch can be unlocked quickly and efficiently and customized to different locking strengths without changing the entire pouch. By employing a universal approach, this system simplifies access and reduces the complexity of having multiple unlocking tools, methods or keys. FIG. 16 depicts an embodiment of a one-tap release with a magnet with a strong enough magnetic pull force. The swappable tags 100, 100a, 100b are designed to be interchangeable, allowing users to modify the opening and security level of the pouch by simply using a different tag but without altering any other structural part of the pouch. Furthermore, FIG. 9 shows the embodiments of tags are customizable, offering various levels of access to the device locked inside the pouch with different tag sizes or other configurations. For instance, larger tags may permit smaller partial openings, enabling enough access to interact with the device without fully removing it from the pouch, while other much smaller tags may provide a larger opening for greater access and interaction with the device, still without needing to remove it from the pouch. In school settings, where student safety is a high priority, the common and universal unlocking mechanism becomes especially critical. Schools often require rapid access to secured items, such as electronic devices or essential supplies, in emergency situations. Whether it's a fire drill, a medical emergency, or a lockdown situation, quickly unlocking the pouch with one tap on the magnet is vital, as depicted in FIG. 16.

The universal unlocking system ensures that teachers, staff, and even students can easily release the pin from the tag and open the pouch with minimal effort using the common unlocking tool or means. This accessibility can prevent delays in critical moments, where every second counts. Additionally, since the unlocking mechanism is simple and standardized, it can be easily understood and used across the school environment, ensuring everyone, including students, is prepared to unlock the pouches swiftly.

The integral pin 101 serves as the primary locking mechanism in the closure system, and its novel design addresses several safety concerns. The integral pin 101 system allows for a rapid unlocking process using a universal unlocking tool or mechanism. This ensures that, even in critical situations, users can access the pouch without fumbling with complicated locks, straps, or zippers. Also, loose or detachable small components, especially in environments with children, can pose a choking hazard. Since the pin remains securely attached to the pouch, the risk of a child accidentally swallowing it is minimized. The fixed nature of the pin ensures that no small, loose parts are present during daily use, safeguarding users from the dangers typically associated with smaller detachable components. Many traditional closure systems (such as zippers, clasps, or even mechanical pins) may have sharp or pointed elements that could lead to cuts or abrasions during regular use. However, the integral pin 101 is designed to be smooth and securely embedded within the pouch. Its structure eliminates any exposed sharp edges, reducing the risk of users, especially children, injuring themselves during handling.

When a tag 100, 100a, or 100b is engaged with pin 101, it locks securely in place, restricting the removal of the entire device. The pin 101 is designed to be compatible with all tag variations, enabling users to easily swap tags 100, 100a, 100b depending on their needs. This standardized system ensures versatility and ease of use across different pouch configurations.

The pouch is also adaptable in terms of size, allowing it to accommodate various electronic devices. The height of the pouch can be varied (as seen in FIG. 10), allowing it to securely hold smaller or larger devices or objects. This flexibility makes the pouch suitable for a wide range of devices of objects, from compact smartphones to larger electronic gadgets like tablets.

Additionally, FIG. 11, FIG. 13 and FIG. 15 show that pouch 102 includes translucent and touch-enabled panels 104b and 104c and various openings 104a to enable user interaction with the device without fully removing it from the pouch, allowing users to see and interact with the device while it remains enclosed. However, the user could not clearly see text, images, or media on their devices. These translucent areas provide somewhat visibility without fully removing the device from the pouch, enhancing user experience by allowing minimal interaction with the device. Larger translucent areas may be incorporated in some designs, enabling even more interaction, such as using the device's touch screen without removing it from the pouch.

FIG. 9 shows the standardized receiving hole 110 on all tags 100 to receive the pin, ensuring that each tag 100, 100a, 100b fits onto the integral pin 101 without needing modifications. This feature allows users to switch between different tags effortlessly while maintaining compatibility across various pouch designs.

The pouch's closure system also incorporates an unlocking mechanism that allows users to fully open the pouch whenever or wherever needed. This mechanism disengages the pin 101 from the tag 100, returning the pouch to its full-size opening. Once unlocked, the device can be easily removed or inserted into the pouch, providing quick access when necessary or whenever or wherever needed.

In conclusion, the present invention offers a secure and adaptable apparatus for housing mobile electronic devices, effectively reducing distractions by concealing the screen while maintaining access to essential functions. The integral pin and removable tag system provides a novel solution for customizable security, allowing users to adjust or replace tags to meet varying security requirements without altering the pouch's fundamental structure.

The ramifications of this invention are significant in environments where controlled access to devices is crucial, such as schools, workplaces, and other institutions. By incorporating a common universal unlocking tool, the apparatus ensures that multiple pouches can be swiftly unlocked during emergencies, enhancing safety and responsiveness. This feature makes the invention highly adaptable for coordinated use among many users, providing both security and convenience.

The scope of the invention extends beyond the specific embodiments described herein. The flexible access control, safety features, and durable construction allow for modifications and variations that address different needs and settings. The invention's design ensures that it remains functional and responsive to varying conditions, offering a balance between usability and distraction control. It is intended that the appended claims cover all such modifications and variations that fall within the true spirit and scope of the invention.

The invention claimed is:

1. An apparatus for securely housing a mobile electronic device while allowing user interaction, comprising:
a pouch configured to receive the mobile electronic device, the pouch having a main opening;
an integral pin permanently affixed to the pouch adjacent to the main opening;
swappable tags with standardized receiving holes engaging the integral pin to secure the main opening, the tags being interchangeable to modify the opening size without altering the pouch's structure;
wherein the pouch includes design features selected from touch-enabled panels or access openings, permitting user interaction with the device without its removal.

2. The apparatus of claim 1, wherein larger swappable tags permit smaller openings, limiting access to the device.

3. The apparatus of claim 1, wherein smaller swappable tags provide larger openings for greater access.

4. The apparatus of claim 1, wherein the integral pin enhances safety by eliminating small, detachable components that could pose hazards.

5. The apparatus of claim 1, wherein the pouch reduces distractions by concealing the device's screen.

6. An apparatus providing adjustable security levels for a mobile electronic device using a universal unlocking mechanism, comprising:
a pouch configured to receive the mobile electronic device, the pouch having a main opening;
an integral pin permanently attached adjacent to the main opening of the pouch;
swappable tags engaging the integral pin to secure the main opening, each tag requiring a specific level of magnetic pull force or electrical signal strength to release the pin;
a universal unlocking mechanism comprising a common unlocking means capable of releasing the integral pin from multiple swappable tags requiring that level of force or less;
wherein the pouch includes design features selected from touch-enabled panels or access openings, permitting user interaction with the device without its removal.

7. The apparatus of claim 6, wherein the common unlocking means comprises magnets or detachers with varying strengths corresponding to the specific levels required by the swappable tags.

8. The apparatus of claim 6, wherein the integral pin enhances safety by eliminating small, detachable components that could pose hazards.

9. The apparatus of claim 6, wherein the pouch is constructed from durable material suitable for high-traffic environments.

10. The apparatus of claim 6, wherein the pouch reduces distractions by concealing the device's screen.

11. An apparatus for controlling access to a mobile electronic device using interchangeable locking mechanisms, comprising:
a pouch configured to house the mobile electronic device, the pouch having a main opening;
an integral pin permanently affixed to the pouch adjacent to the main opening;
interchangeable swappable tags, each tag engaging with the integral pin to secure the main opening, each tag equipped with an unlocking mechanism selected from physical key mechanisms, magnets, detachers, or electrical signals;
wherein the tags are replaceable without altering the integral pin or any other part of the pouch, allowing adjustment of security features;
wherein the pouch includes design features selected from touch-enabled panels or access openings, permitting user interaction with the device without its removal.

12. The apparatus of claim 11, wherein the swappable tags are customizable in size and configuration, offering various levels of access to the device.

13. The apparatus of claim 11, wherein the integral pin enhances safety by eliminating small, detachable components that could pose hazards.

14. The apparatus of claim 11, wherein the apparatus facilitates rapid unlocking in critical situations using a universal unlocking tool compatible with multiple pouches equipped with the swappable tags.

15. The apparatus of claim 11, wherein the pouch reduces distractions by concealing the device's screen.
